(19) United States
(12) Patent Application Publication
(10) Pub. No.: US 2013/0271645 A1
(43) Pub. Date: Oct. 17, 2013

(54) DIGITAL PHOTOGRAPHING APPARATUS, METHOD OF CONTROLLING THE SAME AND COMPUTER PROGRAM PRODUCT HAVING RECORDED THEREON A PROGRAM FOR EXECUTING THE METHOD

(71) Applicant: SAMSUNG ELECTRONICS CO., LTD., Suwon-si (KR)

(72) Inventors: Jeong-yong Park, Suwon-si (KR); Soon-keun Chang, Suwon-si (KR)

(21) Appl. No.: 13/912,379

(22) Filed: Jun. 7, 2013

Related U.S. Application Data
(62) Division of application No. 12/859,886, filed on Aug. 20, 2010.

(30) Foreign Application Priority Data
Aug. 24, 2009 (KR) 10-2009-0078173

(51) Int. Cl. H04N 5/232

(52) U.S. Cl. CPC H04N 5/23212
USPC 348/349

(57) ABSTRACT

A digital photographing apparatus, a method of controlling the same, and a recording medium having recorded thereon a program for executing the method for obtaining a plurality of clear sections in a plurality of images and combining such clear section into a final image. The digital photographing apparatus including: a lens unit including a focusing lens that adjusts a focal length; an image capturing device that obtains image data from incident light; a border image data obtaining unit that obtains border image data from image data obtained by the image capturing device; and a clear image determining unit that determines an image including an area that is the clearest from among images that respectively correspond to a plurality of image data.

### CROSS-REFERENCE TO RELATED PATENT APPLICATIONS

This application is a divisional application of U.S. patent application Ser. No. 12/859,886, filed Aug. 20, 2010, which claims the benefit of Korean Patent Application No. 10-2009-0078173, filed on Aug. 24, 2009, in the Korean Intellectual Property Office, the disclosure of which is incorporated herein in its entirety by reference.

### BACKGROUND

The present invention relates to a digital photographing apparatus, a method of controlling the same, and a recording medium having recorded thereon a program for executing the method, and more particularly, to a digital photographing apparatus in which user convenience is maximized when a subject is photographed while varying a distance between the subject and the digital photographing apparatus, a method of controlling the same, and a recording medium having recorded thereon a program for executing the method.

Generally, digital photographing apparatuses obtain data from light that is incident on an image capturing device and store the obtained data in a storage medium or display an image on a display unit. Digital photographing apparatuses focus on a certain subject from among subjects to be photographed and then obtain image data from light that is incident on the image capturing device.

Conventional digital photographing apparatuses have an automatic focus-on function. Thus, when photographing is performed using a conventional digital photographing apparatus, the conventional digital photographing apparatus focuses on a certain subject from among a plurality of subjects to be photographed and then obtains image data. However, the certain subject that is focused on by the digital photographing apparatus may not be the subject that the user desires the digital photographing apparatus to focus on. When this occurs, the user has to take the photograph again. However, due to the time difference between the initial photographing that has been already performed and the subsequent photographing, the desired image may not be obtained.

### SUMMARY

The present invention provides a digital photographing apparatus in which user convenience is maximized when a subject is photographed while varying a distance between the subject and the digital photographing apparatus, a method of controlling the same, and a recording medium having recorded thereon a program for executing the method.

According to an aspect of the present invention, there is provided a digital photographing apparatus including: a lens unit including a focusing lens adjustable to a focal length; an image capturing device that obtains image data from incident light that is incident on the image capturing device through the lens unit; a border image data obtaining unit that obtains border image data from image data that is obtained by the image capturing device; and a clear image determining unit that determines an image including an area that is the clearest from among images that respectively correspond to a plurality of image data, wherein, when the focusing lens of the lens unit is controlled to vary the focal length, the image capturing device obtains first through n-th image data (where n is an integer), and the border image data obtaining unit obtains first through n-th border image data from the first through n-th image data, and the clear image determining unit determines an image including a first area that is the clearest from among first through n-th images that respectively correspond to the first through n-th border image data, by using the first through n-th border image data, and the clear image determining unit determines an image including a second area that is the clearest from among the first through n-th images that respectively correspond to the first through n-th border image data and that is different from the first area, by using the first through n-th border image data.

The apparatus may further include an image matching unit correcting image data about an image so that the image and another image may be matched with each other.

The border image data obtaining unit may obtain a first result by applying a Gaussian filter to image data by using a first standard deviation and obtain a second result by applying the Gaussian filter to the image data by using a second standard deviation that is different from the first standard deviation and then, may obtain border image data from a difference between the first result and the second result.

The apparatus may further include a final image data obtaining unit obtaining image data corresponding to the image including the first area that is the clearest and image data corresponding to the image including the second area that is the clearest and obtaining final image data corresponding to a final image in which both the first area and the second area are clear.

The apparatus may further include a display unit displaying a final image, and after the final image is displayed on the display unit, if any one of the first and second areas is selected, an image including the selected area that is the clearest, from among the first through n-th images, is displayed on the display unit.

According to another aspect of the present invention, there is provided a digital photographing apparatus including: a lens unit including a focusing lens adjustable to a focal length; an image capturing device that obtains image data from incident light that is incident on the image capturing device via the lens unit; a border image data obtaining unit that obtains border image data from image data that is obtained by the image capturing device; a clarity data obtaining unit that obtains a difference between maximum border image data and minimum border image data in an area k×l based on a pixel (x,y) of a border image that is obtained from the border image data obtained by the border image data obtaining unit, as clarity data of the pixel (x,y); and a clear image determining unit that determines an image including an area that is the clearest from among images that respectively correspond to a plurality of image data, wherein, when the focusing lens of the lens unit is controlled to vary the focal length, the image capturing device obtains first through n-th image data (where n is an integer), and the border image data obtaining unit obtains first through n-th border image data from the first through n-th image data, and obtains a first result that is obtained by applying a Gaussian filter to m-th image data by using a first standard deviation and obtains a second result that is obtained by applying the Gaussian filter to the m-th image data by using a second standard deviation that is different from the first standard deviation, and then obtains m-th border image data (where 1≦m≦n) from a difference between the first result and the second result, and the clarity data obtaining unit obtains clarity data in each of pixels that respectively correspond to the first through n-th border images, and the clear image determining unit determines one image from among first through n-th images, which corresponds to a border image that represents the greatest clarity data in each of pixels that respectively correspond to the first through n-th border images, as a clear image in the pixel.

The apparatus may further include an image matching unit that corrects image data about an image so that the image and another image may be matched with each other.

The apparatus may further include a final image data obtaining unit that obtains image data in a pixel that corresponds to a pixel (x,y) from an image that corresponds to a border image having the greatest clarity data in the pixel that corresponds to the pixel (x,y) from among the first through n-th border images and obtaining final image data.

The apparatus may further include a display unit that displays a final image, and after the final image is displayed on the display unit, if any one of the first and second areas is selected, an image corresponding to a border image that represents the greatest clarity data in the selected area, from among the first through n-th images, is displayed on the display unit.

According to another aspect of the present invention, there is provided a method of controlling a digital photographing apparatus, the method including: obtaining first through n-th image data (where n is an integer) by varying a focal length; obtaining first through n-th border image data from the first through n-th image data; determining an image including a first area that is the clearest from among first through n-th images that respectively correspond to the first through n-th border image data by using the first through n-th border image data; and determining an image including a second area that is the clearest from among the first through n-th images that respectively correspond to the first through n-th border image data so that the second area is different from the first area, by using the first through n-th border image data.

The determining of the image including the first area and the determining of the image including the second image may be performed after the first through n-th images are matched with one another.

The obtaining of the first through n-th border image data may include obtaining a first result that is obtained by applying a Gaussian filter to m-th image data by using a first standard deviation and obtaining a second result that is obtained by applying the Gaussian filter to the m-th image data by using a second standard deviation that is different from the first standard deviation and then obtaining m-th border image data (where 1≦m≦n) from a difference between the first result and the second result.

The method may further include obtaining image data corresponding to the image including the first area that is the clearest and image data corresponding to the image including the second area that is the clearest and obtaining final image data corresponding to a final image in which both the first area and the second area are clear.

The method may further include, after the final image is displayed on the display unit, if any one of the first and second areas is selected, displaying an image including the selected area that is the clearest, from among the first through n-th images on the display unit.

According to another aspect of the present invention, there is provided a method of controlling a digital photographing apparatus, the method including: obtaining first through n-th image data (where n is an integer) by varying a focal length; obtaining first through n-th border image data from the first through n-th image data, obtaining a first result that is obtained by applying a Gaussian filter to m-th image data by using a first standard deviation and obtaining a second result that is obtained by applying the Gaussian filter to the m-th image data by using a second standard deviation that is different from the first standard deviation, and then obtaining m-th border image data (where 1≦m≦n) from a difference between the first result and the second result; obtaining a difference between maximum border image data and minimum border image data in an area k×l based on a pixel (x,y) of a border image that is obtained from the first through n-th border image data obtained by a border image data obtaining unit, as clarity data of the pixel (x,y) and obtaining clarity data in each of pixels that respectively correspond to the first through n-th border images; and determining one image from among first through n-th images, which corresponds to a border image that represents the greatest clarity data in each of pixels that respectively correspond to the first through n-th border images, as a clear image in the pixel.

The determining of the one image may be performed after the first through n-th images are matched with one another.

The method may further include obtaining image data in a pixel that corresponds to a pixel (x,y) from an image that corresponds to a border image having the greatest clarity data in the pixel that corresponds to the pixel (x,y) from among the first through n-th border images and obtaining final image data.

The method may further include, after the final image obtained from the final image data is displayed on a display unit, if any one of the first and second areas is selected, displaying an image corresponding to a border image that represents the greatest clarity data in the selected area, from among the first through n-th images on the display unit.

According to another aspect of the present invention, there is provided

a computer program product, comprising a computer usable medium having a computer readable program code embodied therein, the computer readable program code adapted to be executed to implement one of the above-described methods.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic block diagram of a digital photographing apparatus according to an embodiment of the present invention;

FIG. 2 is a block diagram of a portion of the digital photographing apparatus of FIG. 1;

FIGS. 3A through 3C are schematic conceptual diagrams of first, second, and third images that are obtained by varying a focal length in the digital photographing apparatus of FIG. 1, according to an embodiment of the present invention;

FIGS. 4A through 4C are schematic conceptual diagrams of border images obtained from first through n-th border image data that are obtained by a border image data obtaining unit of the digital photographing apparatus of FIG. 1, according to an embodiment of the present invention;

FIG. 5 is a schematic block diagram of a portion of a digital photographing apparatus according to another embodiment of the present invention;

FIG. 6 schematically illustrates a final image that is obtained by the digital photographing apparatus of FIG. 5, according to an embodiment of the present invention;

FIG. 7 is a flowchart illustrating a method of controlling a digital photographing apparatus according to an embodiment of the present invention;

FIG. 8 is a schematic block diagram of a portion of a digital photographing apparatus according to another embodiment of the present invention;

FIG. 9 is a schematic conceptual diagram for explaining an operation of obtaining clarity data by using the digital photographing apparatus of FIG. 8, according to an embodiment of the present invention;

FIG. 10 is a schematic block diagram of a portion of a digital photographing apparatus according to another embodiment of the present invention; and

FIG. 11 is a flowchart illustrating a method of controlling a digital photographing apparatus according to another embodiment of the present invention.

### DETAILED DESCRIPTION OF THE EMBODIMENTS

Hereinafter, the present invention will be described in detail by explaining exemplary embodiments of the invention with reference to the attached drawings.

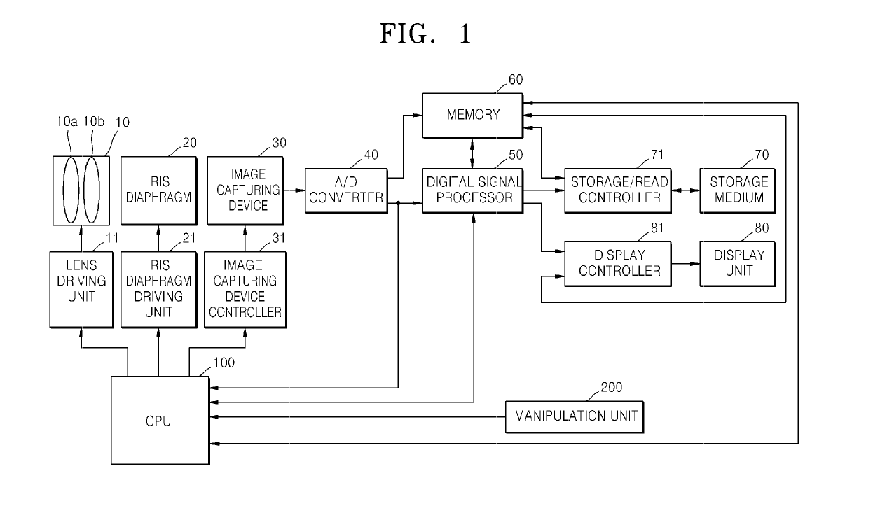

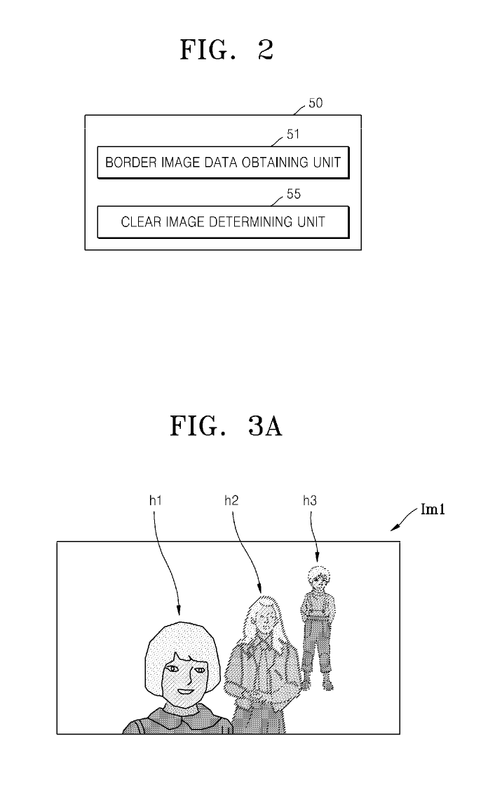

FIG. 1 is a schematic block diagram of a digital photographing apparatus according to an embodiment of the present invention, and FIG. 2 is a block diagram of a portion of the digital photographing apparatus of FIG. 1.

The overall operation of the digital photographing apparatus of FIG. 1 is controlled by a central processing unit (CPU) 100. The digital photographing apparatus of FIG. 1 includes a manipulation unit 200 for generating an electrical signal by user manipulation, such as a button, a keyboard, touch pad, etc. The electrical signal generated by the manipulation unit 200 is transmitted to the CPU 100 so that the CPU 100 may control the digital photographing apparatus of FIG. 1 according to the electrical signal.

In a photographing mode, as the electrical signal generated by user manipulation is applied to the CPU 100, the CPU 100 controls a lens driving unit 11, an iris diaphragm driving unit 21, and an image capturing device controller 31 according to the electrical signal. As such, the position of a lens in a lens unit 10, the degree of opening of an iris diaphragm 20, and sensitivity of an image capturing device 30 are controlled. The lens unit 10 includes a focusing lens 10a that adjusts a focal length, and a lens 10b. The image capturing device 30 generates data from input light, and an analog/digital (A/D) converter 40 converts analog data that is output by the image capturing device 30 into digital data. The A/D converter 40 may not be present due to a characteristic of the image capturing device 30.

The data generated by the image capturing device 30 may be input to a digital signal processor 50 via a memory 60 or may be directly input to the digital signal processor 50. If necessary, the data may be input to the CPU 100. Here, the memory 60 may be a read only memory (ROM) or a random access memory (RAM).

The digital signal processor 50 performs digital signal processing, such as gamma correction or white balance setting, if necessary. Also, as will be described later, the digital signal processor 50 includes a border image data obtaining unit 51 (FIG. 2) and a clear image determining unit 55 so that user convenience is maximized when a subject is photographed while varying a distance between the subject and the digital photographing apparatus. The border image data obtaining unit 51 and the clear image determining unit 55 may be an integral part of the digital signal processor 50 or may comprise additional non-integral elements. Furthermore, the border image data obtaining unit 51 and the clear image determining unit 55 may be a portion of the digital signal processor 50 or may be separate from the digital signal processor 50. In other words, it is sufficient that the digital photographing apparatus according to the present embodiment includes the border image data obtaining unit 51 and the clear image determining unit 55. Functions of the border image data obtaining unit 51 and the clear image determining unit 55 will be described later.

Data output from the digital signal processor 50 are transmitted to a display controller 81 (FIG. 1) via the memory 60 or is transmitted directly to the display controller 81. The display controller 81 controls a display unit 80 to display a digital image on the display unit 80. The data output from the digital signal processor 50 is input to a storage/read controller 71 via the memory 60 or is input directly to the storage/read controller 71. The storage/read controller 71 stores the data in a storage medium 70 according to an electrical signal input by user manipulation or automatically. The storage/read controller 71 reads the data from a file stored in the storage medium 70, inputs the read data to the display controller 81 via the memory 60 or via other paths so that an image may be displayed on the display unit 80. The storage medium 70 may be attachable and detachable or may be permanently installed in the digital photographing apparatus of FIGS. 1 and 2.

The above-described elements are not always essential in the digital photographing apparatus of FIGS. 1 and 2. In other words, as occasion demands, the iris diaphragm driving unit 21 and the display unit 80 may not be provided. It is sufficient that the digital photographing apparatus according to the present embodiment includes a lens unit 10 including the focusing lens 10a, the image capturing device 30, the border image data obtaining unit 51, and the clear image determining unit 55. Functions of the border image data obtaining unit 51 and the clear image determining unit 55 will be described later with reference to the attached drawings.

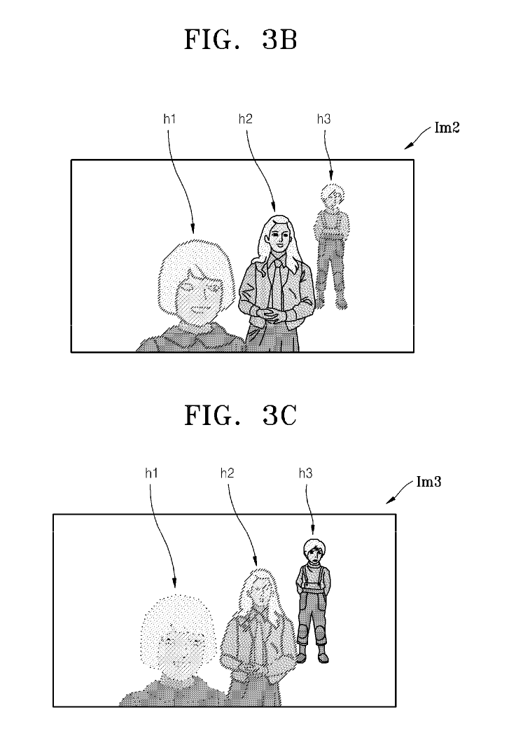

In the digital photographing apparatus of FIGS. 1 and 2, when an electrical signal is input by user manipulation, the focusing lens 10a of the lens unit 10 is controlled to vary a focal length so that the image capturing device 30 may obtain first through n-th image data (where n is an integer). In other words, the image capturing device 30 obtains a plurality of image data by varying a focal length. FIGS. 3A through 3C are schematic conceptual diagrams of first, second, and third images Im1, Im2, and Im3 that are obtained by varying a focal length in the digital photographing apparatus of FIGS. 1 and 2, according to an embodiment of the present invention. FIG. 3A is a schematic conceptual diagram of the first image Im1 that is obtained by focusing on a first person h1 that is the closest to the digital photographing apparatus of FIGS. 1 and 2. FIG. 3B is a schematic conceptual diagram of the second image Im2 that is obtained by focusing on a second person h2 that is next to the digital photographing apparatus of FIGS. 1 and 2. FIG. 3C is a schematic conceptual diagram of the third image Im3 that is obtained by focusing on a third person h3 that is the farthest from the digital photographing apparatus of FIGS. 1 and 2.

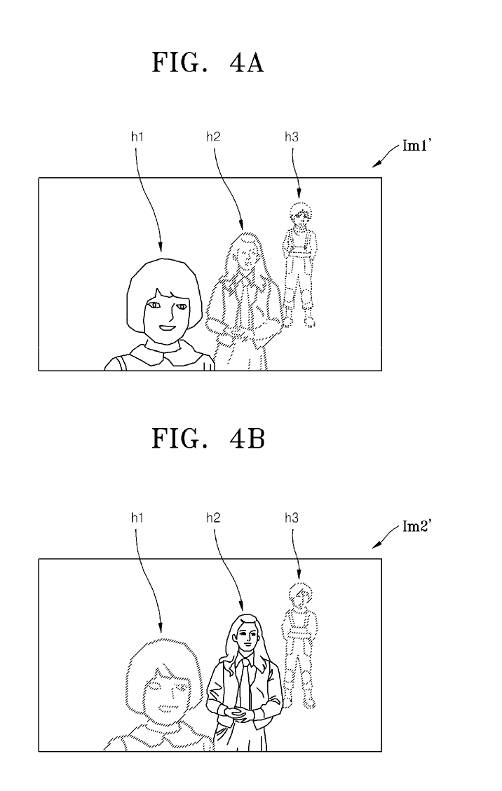

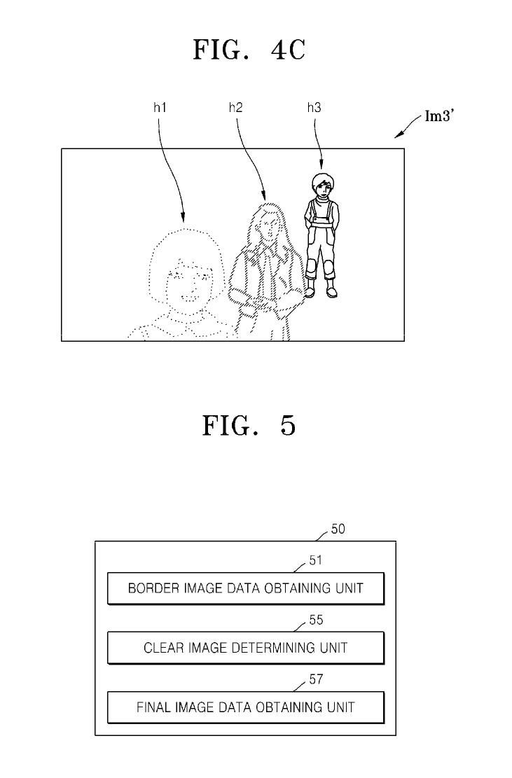

When the first through n-th image data are obtained, the border image data obtaining unit 51 obtains first through n-th border image data from the first through n-th image data. FIGS. 4A through 4C are schematic conceptual diagrams of first, second, and third border images Im1′, Im2′, and Im3′ obtained from the first through n-th border image data that are obtained by the border image data obtaining unit 51 of the digital photographing apparatus of FIGS. 1 and 2, according to an embodiment of the present invention. Referring to FIGS. 4A through 4C, only border contours of subjects remain.

Referring to FIG. 4A, since Im1′ is the first border image obtained from the first image Im1 obtained by focusing on the first person h1 that is the closest to the digital photographing apparatus of FIGS. 1 and 2, a border of the first person h1 is clear, and borders of the second person h2 and the third person h3 are not clear. In particular, since the third person h3 is the farthest from the digital photographing apparatus of FIGS. 1 and 2, the border of the third person h3 is less clear than the border of the second person h2.

Referring to FIG. 4B, since Im2′ is the second border image obtained from the second image Im2 obtained by focusing on the second person h2 that is next to the digital photographing apparatus of FIGS. 1 and 2, the border of the second person h2 is clear, and the borders of the first person h1 and the third person h3 are not clear.

Referring to FIG. 4C, since Im3′ is the third border image obtained from the third image Im3 obtained by focusing on the third person h3 that is the farthest from the digital photographing apparatus of FIGS. 1 and 2, the border of the third person h3 is clear, and the borders of the first person h1 and the second person h2 are not clear. In particular, since the first person h1 is the closest to the digital photographing apparatus of FIGS. 1 and 2, the border of the first person h1 is less clear than the border of the second person h2.

The clear image determining unit 55 determines an image including an area that is the clearest from among images that respectively correspond to a plurality of image data. First, the clear image determining unit 55 determines an image including a first area that is the clearest from among first through n-th images that respectively correspond to first through n-th border image data, by using the first through n-th border image data. Also, the clear image determining unit 55 determines an image including a second area that is the clearest from among the first through n-th images that respectively correspond to the first through n-th border image data and that is different from the first area, by using the first through n-th border image data.

For example, referring to FIGS. 4A through 4C, when the first person h1 is the first area, the clear image determining unit 55 determines the first image Im1 in which the first person h1 is the clearest, from among the first, second, and third images Im1, Im2, and Im3 as an image in which the first person h1 is the clearest. After that, when the second person h2 is the second area, the clear image determining unit 55 determines the second image Im2 in which the second person h2 is the clearest, from among the first, second, and third images Im1, Im2, and Im3 as an image in which the second person h2 is the clearest. When the third person h3 is the third area, the clear image determining unit 55 determines the third image Im3 in which the third person h3 is the clearest, from among the first, second, and third images Im1, Im2, and Im3 may also be determined as an image in which the third person h3 is the clearest.

The first, second, and third persons h1, h2, and h3 are photographed, as described with reference to FIGS. 3A through 3C and FIGS. 4A through 4C. However, the present invention is not limited to this, and when a plurality of subjects are photographed, the digital photographing apparatus of FIGS. 1 and 2 obtains a plurality of image data by varying a focal length.

In the digital photographing apparatus according to the present embodiment, a plurality of image data are obtained from a signal that is input at one time by user manipulation, by varying a focal length so that the user may select a desired image and user convenience may be maximized. In particular, when an undesired subject that is an image obtained by a conventional digital photographing apparatus having an automatic focus-on function is focused on, the user does not need to photograph again.

The digital photographing apparatus of FIGS. 1 and 2 obtains a plurality of image data by varying a focal length according to a signal input by user manipulation. Thus, user hand shake may slightly occur between a time at which first image data is obtained and a time at which second image data is obtained. Thus, the digital photographing apparatus of FIGS. 1 and 2 may further include an image matching unit that corrects image data about an image so that the image may be matched with another image. The image matching unit may match first through n-th images and then, the clear image determining unit 55 may determine an image including an area that is the clearest from among the first through n-th images that respectively correspond to first through n-th image data.

The border image data obtaining unit 51 may obtain border image data by using various methods. In this case, it is efficient to use a Gaussian filter. In other words, the border image data obtaining unit 51 may obtain a first result that is obtained by applying the Gaussian filter using a first standard deviation to image data and a second result that is obtained by applying the Gaussian filter using a second standard deviation that is different from the first standard deviation and then may obtain border image data from a difference between the first result and the second result. Obtaining of the border image data in this way is described in detail at the web site http://micro.magnet.fsu.edu/primer/java/digitalimaging/processinq/diffgaussans/index.html (as downloaded on Jan. 30, 2010) that is operated by the National High Magnetic Field Laboratory of the Florida State University, herein, incorporated by reference.

The Gaussian filter applied to coordinates (0,0) is expressed as Equation 1 (where σ is a predetermined standard deviation):

$$G ( x , y ) = \frac{1}{2 π {σ}_{1}^{2}} exp ( - \frac{( {x}^{2} + {y}^{2} )}{2 {σ}_{1}^{2}} ) \qquad ( 1 )$$

Thus, when the Gaussian filter is applied to a pixel, assuming that the coordinates of the pixel are (0,0), the pixel has a resultant value I_{G}, as expressed by Equation 2. Here, I(x,y) is data in a pixel corresponding to coordinates (x,y) assuming that the coordinates of the pixel is (0,0), and Im is an overall image.

$${I}_{G} = {\sum }_{( x , y ) ∈ Im} \frac{1}{2 π {σ}_{1}^{2}} exp ( - \frac{( {x}^{2} + {y}^{2} )}{2 {σ}_{1}^{2}} ) \times I ( x , y ) \qquad ( 2 )$$

The border image data represents a difference between the first result that is obtained by applying the Gaussian filter to the image data by using the first standard deviation σ₁ and the second result that is obtained by applying the Gaussian filter to the image data by using the second standard deviation σ₂ that is different from the first standard deviation σ₁. Thus, when coordinates of a pixel are (0,0), the border image data of the pixel may be expressed by Equation 3 (where, σ₁<σ₂). Clarity of a border image may be set by adjusting a standard deviation.

$$EI = {\sum }_{( x , y ) ∈ Im} \{ \frac{1}{2 π {σ}_{1}^{2}} exp ( - \frac{( {x}^{2} + {y}^{2} )}{2 {σ}_{1}^{2}} ) - \frac{1}{2 π {σ}_{2}^{2}} exp ( - \frac{( {x}^{2} + {y}^{2} )}{2 {σ}_{2}^{2}} ) \} \times I ( x , y ) \qquad ( 3 )$$

In this way, the border image data obtaining unit 51 may obtain border image data from each of pixels of the first through n-th images.

The digital photographing apparatus of FIGS. 1 and 2 may also be used to obtain information about distances between a plurality of subjects. In other words, when a plurality of image data are obtained while varying a focal length and the clear image determining unit 55 determines image data focused on a first subject and image data focused on a second subject, information about a distance between the first subject and the second subject may be obtained by using focal length information when the image data focused on the first subject are obtained and focal length information when the image data focused on the second subject are obtained. In a conventional digital photographing apparatus, a laser scanner has to be used or infrared (IR) patterns have to be formed on a subject so as to obtain the information about the distance between the first subject and the second subject. In this case, expensive equipment has to be used. However, in the digital photographing apparatus of FIGS. 1 and 2, the information about the distance between the first and second subjects may be efficiently obtained at low cost.

FIG. 5 is a schematic block diagram of a portion of a digital photographing apparatus according to another embodiment of the present invention. A difference between the digital photographing apparatus according to the present embodiment and the digital photographing apparatus of FIGS. 1 and 2 is that the digital photographing apparatus of FIG. 5 further includes a final image data obtaining unit 57. The final image data obtaining unit 57 may be a portion of the digital signal processor 50, as illustrated in FIG. 5, an additional element, or a portion of another element of FIG. 1.

After the clear image determining unit 55 determines an image including a first area that is the clearest from among first through n-th images that respectively correspond to first through n-th border image data and also determines an image including a second area that is the clearest from among the first through n-th images that respectively correspond to the first through n-th border image data, as described in the digital photographing apparatus of FIGS. 1 and 2, the final image data obtaining unit 57 obtains final image data from image data that respectively correspond to the determined images. Specifically, the final image data obtaining unit 57 obtains image data corresponding to the image including the first area that is the clearest and image data corresponding to the image including the second area that is the clearest, thereby obtaining final image data corresponding to a final image in which both the first area and the second area are clear.

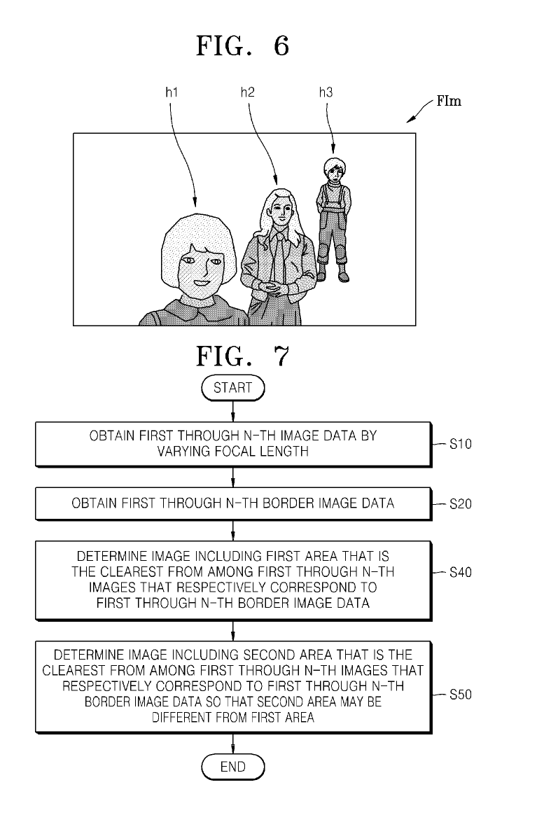

For example, when the first, second, and third images Im1, Im2, and Im3 illustrated in FIGS. 3A through 3C are obtained, the first, second, third border images Im1′, Im2′, and Im3′ illustrated in FIGS. 4A through 4C are obtained and the first person h1 corresponds to the first area and the second person h2 corresponds to the second area, the final image data obtaining unit 57 obtains image data corresponding to a portion of the first image Im1 in which the first person h1 is the clearest, in the area in which the first person h1 stands, and image data corresponding to a portion of the second image Im2 in which the second person h2 is the clearest, in the area in which the second person h2 stands, thereby obtaining the final image data. The final image data obtaining unit 57 obtains the final image data by obtaining image data corresponding to a portion of the third image Im3 in which the third person h3 is the clearest, in the area in which the third person h3 stands. In this case, the final image data obtaining unit 57 obtains image data corresponding to a portion of any one image of the first through third images Im1, Im2, and Im3 in areas other than the area in which the first, second, or third person h1, h2 or h3 stands. FIG. 6 schematically illustrates a final image FIm that is obtained by the digital photographing apparatus of FIG. 5, according to an embodiment of the present invention.

In a conventional digital photographing apparatus, only the focused-on subject is clear and other subjects are not clear. However, in the digital photographing apparatus of FIG. 5, image data may be obtained about an image in which a plurality of subjects located at different distances from the digital photographing apparatus of FIG. 5 are clear.

The digital photographing apparatus of FIG. 5 may further include a display unit such as the display unit 80 of FIG. 1 that displays an image. In such an embodiment, the final image FIm may be displayed on the display unit 80. In this case, if any one of the first and second areas is selected, an image including the selected area that is the clearest, from among the first through n-th images, may be displayed on the display unit 80. Specifically, if the first person h1 is the first area is selected when the final image FIm is displayed on the display unit 80, the first image Im1 including the area in which the first person h1 that is the clearest stands, from among the first, second, and third images Im1, Im2, and Im3, is displayed on the display unit 80. In this case, the user may select a focused-on subject while seeing the final image FIm and may select and check a desired image (in the above example, the first image Im1) so that user convenience may be maximized.

FIG. 7 is a flowchart illustrating a method of controlling a digital photographing apparatus according to an embodiment of the present invention. Referring to FIG. 7, in the method of controlling the digital photographing apparatus according to the present embodiment, in Operation S10, first through n-th image data (where n is an integer) are obtained by varying a focal length. In Operation S20, first through n-th border image data are obtained from the first through n-th image data. As described above with reference to Equations 1 through 3, the border image data may be obtained from a difference between a first result and a second result after obtaining the first result that is obtained by applying a Gaussian filter to image data by using a first standard deviation and the second result that is obtained by applying the Gaussian filter to image data by using a second standard deviation that is different from the first standard deviation.

In Operation S40, an image including a first area that is the clearest from among first through n-th images that respectively correspond to first through n-th border image data is determined by using the first through n-th border image data. Also, in Operation S50, an image including a second area that is the clearest from among the first through n-th images that respectively correspond to the first through n-th border image data is determined by using the first through n-th border image data. Here, the second area is different from the first area.

In the method of controlling the digital photographing apparatus of FIG. 7, a plurality of image data are obtained from a signal that is input at one time by user manipulation, by varying a focal length so that a user may select a desired image and user convenience may be maximized.

In the method of controlling the digital photographing apparatus of FIG. 7, a plurality of image data are obtained from a signal that is input at one time by user manipulation, by varying a focal length. Thus, user hand shake may slightly occur between a time at which first image data is obtained and a time at which second image data is obtained. Thus, Operations S40 and/or S50 may be performed after the first through n-th images are matched with one another.

After Operation S50, the method may further include obtaining image data corresponding to the image including the first area that is the clearest and image data corresponding to the image including the second area that is the clearest and obtaining final image data corresponding to a final image in which both the first area and the second area are clear. Here, even in more areas apart from the first and second areas, an image in which an area is clear, may be determined, and by using the image, final image data corresponding to a final image in which the area is clear, may be obtained. Thus, an image in which a plurality of subjects located at different distances from the digital photographing apparatus are clear, may be obtained.

After the final image is displayed on a display unit such as the display unit 80 of FIG. 1, if any one of the first and second areas is selected, the method may further include displaying an image including the selected area that is the clearest, from among the first through n-th images, on a display unit such as the display unit 80 of FIG. 1 so that user convenience may be maximized.

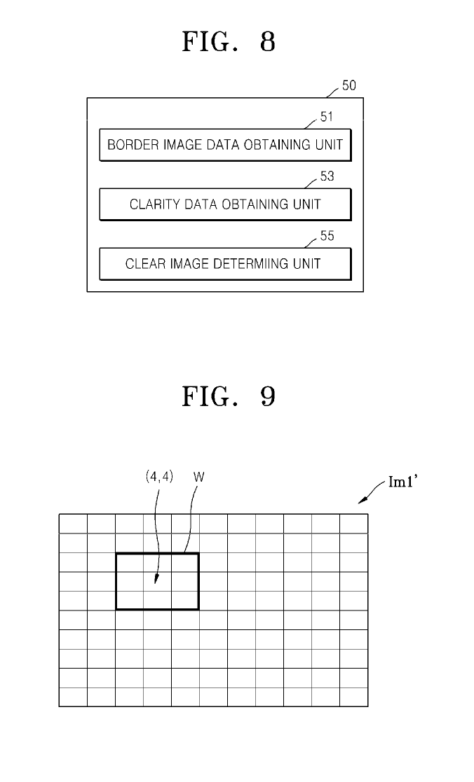

FIG. 8 is a schematic block diagram of a portion of a digital photographing apparatus according to another embodiment of the present invention. The digital photographing apparatus according to the present embodiment may have the structure of FIG. 1, and a digital signal processor such as 50 of FIG. 1 may be constituted to have the structure of FIG. 8. A border image data obtaining unit 51, a clarity data obtaining unit 53, and a clear image determining unit 55 may be an integral part of a digital signal processor 50, as illustrated in FIG. 8, additional non-integral elements of the digital signal processor 50. In other words, it is sufficient that the digital photographing apparatus according to the present embodiment includes the border image data obtaining unit 51, the clarity data obtaining unit 53, and the clear image determining unit 55.

In the digital photographing apparatus according to the present embodiment, if a signal is input by user manipulation, a focusing lens such as 10a of FIG. 1 of a lens unit 10 of FIG. 1 is controlled to vary a focal length so that an image capturing device such as 30 of FIG. 1 may obtain first through n-th image data (where n is an integer). FIGS. 3A through 3C are schematic conceptual diagrams of first, second, and third images Im1, Im2, and Im3 that are obtained by varying a focal length in the digital photographing apparatus of FIGS. 1 and 2, according to an embodiment of the present invention.

When the first through n-th image data are obtained, the border image data obtaining unit 51 obtains first through n-th border image data from the first through n-th image data. FIGS. 4A through 4C are schematic conceptual diagrams of first, second, and third border images Im1′, Im2′, and Im3′ obtained from the first through n-th border image data that are obtained by the border image data obtaining unit 51 of the digital photographing apparatus of FIGS. 1 and 2, according to an embodiment of the present invention. The border image data may be obtained from a difference between a first result and a second result after obtaining the first result that is obtained by applying a Gaussian filter to image data by using a first standard deviation and the second result that is obtained by applying the Gaussian filter to image data by using a second standard deviation that is different from the first standard deviation, as described above with reference to Equations 1 through 3.

The clarity data obtaining unit 53 obtains a difference between maximum border image data and minimum border image data in an area k×l based on a pixel (x,y) of a border image that is obtained from the border image data obtained by the border image data obtaining unit 51, as clarity data of the pixel (x,y). FIG. 9 is a schematic conceptual diagram for explaining an operation of obtaining clarity data by using the digital photographing apparatus of FIG. 8, according to an embodiment of the present invention. For example, as illustrated in FIG. 9, clarity data of a pixel (4,4) of a first border image Im1′ represents a difference between maximum border image data and minimum border image data in pixels included in an area 3×3 (W) based on the pixel (4,4). The area 3×3 is just illustrative, and according to experiments, an area 11×11 is most preferable. In this way, clarity data in each pixel of the first through n-th border images is determined.

The border images of FIGS. 4A through 4C may be images in which only a portion that corresponds to a border of each of the subjects is clear. Thus, when an appropriately wide area, such as the area 11×11, is selected, a portion that does not correspond to the border of each subject is included in the appropriately wide area. Thus, the most part of the maximum difference between the maximum border image data (border image data of a clearest pixel) and the minimum border image data in the appropriately wide area approximately corresponds to the maximum border image data in the properly wide area. The area 11×11 may be interpreted to be an “appropriately” wide area and thus may also be interpreted to be an “appropriately” narrow area. Thus, obtaining of the difference between the maximum border image data and the minimum border image data in the area 11×11 as clarity data of a central pixel of the area 11×11 may be interpreted to provide clarity data to the central pixel of the area 11×11 depending on whether a border of a subject is present in the vicinity of the central pixel, and if the border of the subject is present in the vicinity of the central pixel, obtaining of the difference between the maximum border image data and the minimum border image data in the area 11×11 as clarity data of a central pixel of the area 11×11 may be interpreted to provide clarity data to the central pixel of the area 11×11 according to the clarity of the border of the subject. The border images may be images in which only a portion that corresponds to a border of each of subjects is clear. Even in this case, by obtaining the difference between the maximum border image data and the minimum border image data in the area 11×11 as clarity data of the central pixel of a predetermined area, a similar result based on a similar logic to the above logic may be obtained.

For example, clarity data in a pixel that corresponds to the first person h1 in the first border image Im1′ illustrated in FIG. 4A is greater than clarity data in a pixel that corresponds to the second border image Im2′ illustrated in FIG. 4B or the third border image Im3′ illustrated in FIG. 4C. Here, in the first border image Im1′ of FIG. 4A, clarity data in the pixel that corresponds to a border of the first person h1 and clarity data in the pixel that does not correspond to the border of the first person h1 but corresponds to the first person h1 are greater than clarity data in a pixel that corresponds to the second border image Im2′ illustrated in FIG. 4B or the third border image Im3′ illustrated in FIG. 4C. This is because FIGS. 4A through 4C are schematically illustrated. In other words, in FIG. 4A, the first person h1 is focused on. Thus, in actuality, unlike in FIG. 4A, clearer portions than in FIGS. 4B and 4C are in the border of the first person h1 and in the first person h1 when the first person h1 is represented as a border image.

The clear image determining unit 55 determines an image including the clearest area from among images that respectively correspond to a plurality of image data. Specifically, the clear image determining unit 55 determines one image from among first through n-th images, which corresponds to a border image that represents the greatest clarity data in each of pixels that respectively correspond to the first through n-th border images, as a clear image in the pixel. For example, in a pixel included in the first person h1, a pixel having the greatest clarity data from among pixels that respectively correspond to the first, second, and third images Im1′, Im2′, and Im3′ is a pixel in the first border image Im1′. Thus, the clear image determining unit 55 determines the first image Im1 from among the first, second, and third images Im1, Im2, and Im3 as a clear image in the pixel included in the first person h1. In this way, the clear image determining unit 55 determines clear images in all of the pixels that respectively correspond to the first through n-th border images.

In the digital photographing apparatus of FIG. 8, a plurality of image data are obtained from a signal that is input at one time by user manipulation, by varying a focal length so that a user may select a desired image and user convenience may be maximized. In particular, when an undesired subject that is an image obtained by a conventional digital photographing apparatus having an automatic focus-on function is focused on, the user does not need to take another photograph again.

The digital photographing apparatus of FIG. 8 obtains a plurality of image data by varying a focal length according to a signal input by user manipulation. Thus, user hand shake may slightly occur between a time at which first image data is obtained and a time at which second image data is obtained. Thus, the digital photographing apparatus of FIG. 8 may further include an image matching unit that corrects image data about an image so that an image may be matched with another image. The image matching unit may match first through n-th images and then, the clear image determining unit 55 may determine an image including an area that is the clearest from among the first through n-th images that respectively correspond to first through n-th image data.

The digital photographing apparatus of FIG. 8 may also be used to obtain information about distances between a plurality of subjects. In other words, when a plurality of image data are obtained while varying a focal length and the clear image determining unit 55 determines image data focused on a first subject and image data focused on a second subject, information about a distance between the first subject and the second subject may be obtained by using focal length information when the image data focused on the first subject is obtained and focal length information when the image data focused on the second subject is obtained. In a conventional digital photographing apparatus, a laser scanner has to be used or infrared (IR) patterns have to be formed on a subject so as to obtain the information about the distance between the first subject and the second subject. In this case, expensive equipment has to be used. However, in the digital photographing apparatus of FIG. 8, the information about the distance between the first and second subjects may be efficiently obtained at low cost.

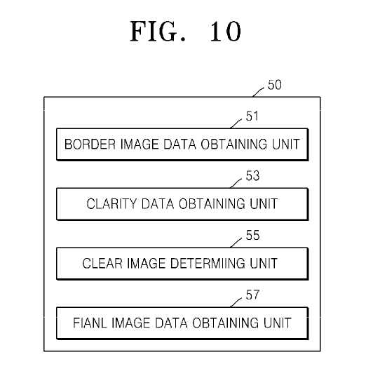

FIG. 10 is a schematic block diagram of a portion of a digital photographing apparatus according to another embodiment of the present invention. A difference between the digital photographing apparatus according to the present embodiment and the digital photographing apparatus of FIG. 8 is that the digital photographing apparatus of FIG. 10 further includes a final image data obtaining unit 57. The final image data obtaining unit 57 may be an integral part of the digital signal processor 50, as illustrated in FIG. 10, an additional non-integral element, or a portion of another element.

After the clear image determining unit 55 determines clear images in all of the pixels that respectively correspond to the first through n-th border images, as described in the digital photographing apparatus of FIG. 8, the final image data obtaining unit 57 obtains final image data from image data that respectively corresponds to the determined images. Specifically, the final image data obtaining unit 57 obtains image data in a pixel that corresponds to a pixel (x,y) from an image that corresponds to a border image having the greatest clarity data in the pixel that corresponds to the pixel (x,y) from among the first through n-th border images, thereby obtaining final image data.

For example, when the first, second, and third images Im1, Im2, and Im3 illustrated in FIGS. 3A through 3C are obtained, the first, second, third border images Im1′, Im2′, and Im3′ illustrated in FIGS. 4A through 4C are obtained, the final image data obtaining unit 57 obtains image data corresponding to a portion of the first image Im1 in which the first person h1 is the clearest, in pixels in which the first person h1 stands, and image data corresponding to a portion of the second image Im2 in which the second person h2 is the clearest, in pixels in which the second person h2 stands, thereby obtaining the final image data. FIG. 6 schematically illustrates a final image FIm that is obtained by the digital photographing apparatus of FIG. 5, according to an embodiment of the present invention.

In a conventional digital photographing apparatus, image data is obtained about an image in which only a focused-on subject is clear and other subjects are not clear. However, in the digital photographing apparatus of FIG. 10, image data about an image in which a plurality of subjects located at different distances from the digital photographing apparatus of FIG. 10 are clear, may be obtained.

The digital photographing apparatus of FIG. 10 may further include a display unit such as the display unit 80 of FIG. 1 that displays an image. In this case, the final image FIm may be displayed on the display unit 80. In this case, if any one of the first and second areas is selected, an image corresponding to a border image that represents the greatest clarity data in the selected area, from among the first through n-th images, may be displayed on the display unit 80. Specifically, if the first person h1 that is the first area is selected when the final image FIm is displayed on the display unit 80, the first image Im1 including the area in which the first person h1 that is the clearest stands, from among the first, second, and third images Im1, Im2, and Im3, is displayed on the display unit 80. In this case, the user may select a focused-on subject while seeing the final image FIm and may select and check a desired image (in the above example, the first image Im1) so that user convenience may be maximized.

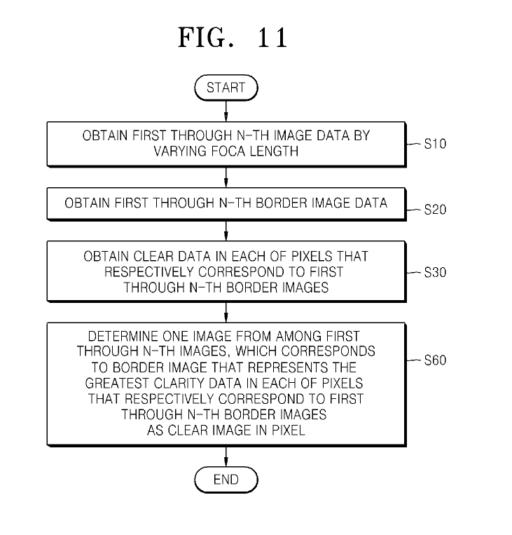

FIG. 11 is a flowchart illustrating a method of controlling a digital photographing apparatus according to another embodiment of the present invention. Referring to FIG. 11, in the method of controlling the digital photographing apparatus according to the present embodiment, in Operation S10, first through n-th image data (where n is an integer) are obtained by varying a focal length. In Operation S20, first through n-th border image data are obtained from the first through n-th image data, and a first result is obtained by applying a Gaussian filter to m-th image data by using a first standard deviation and a second result is obtained by applying the Gaussian filter to m-th image data by using a second standard deviation that is different from the first standard deviation, and then, m-th border image data (where 1≦m≦n) is obtained from a difference between the first result and the second result.

Subsequently, in Operation S30, a difference between maximum border image data and minimum border image data in an area k×l based on a pixel (x,y) of a m-th border image that is obtained from the m-th border image data, is obtained as clarity data of the pixel (x,y) of the m-th border image, and clarity data in each of pixels that respectively correspond to the first through n-th border images are obtained. After that, in Operation S60, one image from among first through n-th images, which corresponds to a border image that represents the greatest clarity data in each of pixels that respectively correspond to the first through n-th border images, are determined as a clear image in the pixel.

In the method of controlling the digital photographing apparatus of FIG. 11, a plurality of image data are obtained from a signal that is input at one time by user manipulation, by varying a focal length so that a user may select a desired image and user convenience may be maximized.

In the method of controlling the digital photographing apparatus of FIG. 11, a plurality of image data are obtained from a signal that is input at one time by user manipulation, by varying a focal length. Thus, user hand shake may slightly occur between a time at which first image data is obtained and a time at which second image data is obtained. Thus, Operation S60 may be performed after the first through n-th images are matched with one another.

After Operation S60, the method may further include obtaining image data in a pixel that corresponds to a pixel (x,y) from an image that corresponds to a border image having the greatest clarity data in the pixel that corresponds to the pixel (x,y) from among the first through n-th border images, thereby obtaining final image data. Thus, an image may be obtained in which a plurality of subjects located at different distances from the digital photographing apparatus are clear.

After the final image is displayed on a display unit such as the display unit 80 of FIG. 1, if any one of the first and second areas is selected, the method may further include displaying an image corresponding to a border image that represents the greatest clarity data in the selected area, from among the first through n-th images, on a display unit 80 of FIG. 1 so that user convenience may be maximized.

A program for executing the method of controlling the digital photographing apparatus according to the above-mentioned embodiments and modified embodiments thereof in the digital photographing apparatus according to the present invention may be recorded on a recording medium. Here, the recording medium may be a storage medium such as the storage medium 70 of FIG. 1, a memory such as the memory 60 of FIG. 1, or an additional recording medium. Here, examples of the recording medium include recording media, such as magnetic storage media (e.g., ROM, floppy disks, hard disks, etc.) and optical recording media (e.g., CD-ROMs, or DVDs).

As described above, in the digital photographing apparatus, the method of controlling the same and the recording medium having recorded thereon a program for executing the method according to the present invention, user convenience may be maximized when a subject is photographed while varying a distance between the subject and the digital photographing apparatus.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context.

Numerous modifications and adaptations will be readily apparent to those skilled in this art without departing from the spirit and scope of the present invention.

What is claimed is:

1. A digital photographing apparatus comprising:
a lens unit comprising a focusing lens adjustable to a focal length;
an image capturing device that obtains image data from incident light that is incident on the image capturing device through the lens unit;
a border image data obtaining unit that obtains border image data from image data obtained by the image capturing device;
a clarity data obtaining unit that obtains a difference between maximum border image data and minimum border image data in an area k×l based on a pixel (x,y) of a border image that is obtained from the border image data obtained by the border image data obtaining unit, as clarity data of the pixel (x,y); and
a clear image determining unit that determines an image that includes an area that is the clearest from among images that respectively correspond to a plurality of image data,
wherein, when the focusing lens of the lens unit is controlled to vary the focal length, the image capturing device obtains first through n-th image data where n is an integer, and
the border image data obtaining unit obtains first through n-th border image data from the first through n-th image data, and obtains a first result that is obtained by applying a Gaussian filter to m-th image data by using a first standard deviation and obtains a second result that is obtained by applying the Gaussian filter to the m-th image data by using a second standard deviation that is different from the first standard deviation, and then obtains m-th border image data, where 1≦m≦n, from a difference between the first result and the second result, and
the clarity data obtaining unit obtains clarity data in each of pixels that respectively correspond to the first through n-th border images, and
the clear image determining unit determines one image from among first through n-th images, which corresponds to a border image that represents the greatest clarity data in each of pixels that respectively correspond to the first through n-th border images, as a clear image in the pixel.

2. The apparatus of claim 1, further comprising an image matching unit that corrects image data so that one of the first through n-th images and another of the first through n-th images may be matched with each other.

3. The apparatus of claim 1, further comprising:
a final image data obtaining unit that obtains image data in a pixel that corresponds to a pixel (x,y) from the image that corresponds to a border image having the greatest clarity data in the pixel that corresponds to the pixel (x,y) from among the first through n-th border images and obtaining final image data.

4. The apparatus of claim 3, further comprising:
a display unit that displays a final image, and after the final image is displayed on the display unit, if any one of the first and second areas is selected, the image corresponding to a border image that represents the greatest clarity data in the selected area, from among the first through n-th images, is displayed on the display unit.

5. A method of controlling a digital photographing apparatus, the method comprising:
obtaining first through n-th image data, where n is an integer by varying a focal length;
obtaining first through n-th border image data from the first through n-th image data, obtaining a first result by applying a Gaussian filter to m-th image data by using a first standard deviation and obtaining a second result by applying the Gaussian filter to the m-th image data by using a second standard deviation that is different from the first standard deviation, and then obtaining m-th border image data, where 1≦m≦n, from a difference between the first result and the second result;
obtaining a difference between maximum border image data and minimum border image data in an area k×l based on a pixel (x,y) of a border image that is obtained from the first through n-th border image data obtained by a border image data obtaining unit, as clarity data of the pixel (x,y) and obtaining clarity data in each of pixels that respectively correspond to the first through n-th border images; and
determining one image from among first through n-th images, which corresponds to the border image that represents the greatest clarity data in each of pixels that respectively correspond to the first through n-th border images, as a clear image in the pixel.

6. The method of claim 5, wherein the determining of the one image is performed after the first through n-th images are matched with one another.

7. The method of claim 5, further comprising obtaining image data in a pixel that corresponds to a pixel (x,y) from the image that corresponds to the border image having the greatest clarity data in the pixel that corresponds to the pixel (x,y) from among the first through n-th border images and obtaining final image data.

8. The method of claim 7, further comprising:
after the final image obtained from the final image data is displayed on a display unit, if any one of the first and second areas is selected, then displaying the image corresponding to the border image that represents the greatest clarity data in the selected area, from among the first through n-th images on the display unit.

9. A computer program product, comprising a computer usable medium having a computer readable program code embodied therein, the computer readable program code adapted to be executed to implement a method of controlling a digital photographing apparatus, the method comprising:
obtaining first through n-th image data, where n is an integer by varying a focal length;
obtaining first through n-th border image data from the first through n-th image data, obtaining a first result that is obtained by applying a Gaussian filter to m-th image data by using a first standard deviation and obtaining a second result that is obtained by applying the Gaussian filter to the m-th image data by using a second standard deviation that is different from the first standard deviation, and then obtaining m-th border image data, where 1≦m≦n, from a difference between the first result and the second result;
obtaining a difference between maximum border image data and minimum border image data in an area k×l based on a pixel (x,y) of a border image that is obtained from the first through n-th border image data obtained by a border image data obtaining unit, as clarity data of the pixel (x,y) and obtaining clarity data in each of pixels that respectively correspond to the first through n-th border images; and
determining one image from among first through n-th images, which corresponds to the border image that represents the greatest clarity data in each of pixels that respectively correspond to the first through n-th border images, as a clear image in the pixel.
